(19) United States
(12) Patent Application Publication
(10) Pub. No.: US 2009/0060632 A1
(43) Pub. Date: Mar. 5, 2009

(54) LOOSE LEAF ENVELOPE

(75) Inventors: A. Scott Wakeman, Ottawa (CA); Vivek W. Sarin, Ottawa (CA); Bernard R. Poirier, Ottawa (CA)

Correspondence Address: CALFEE HALTER & GRISWOLD, LLP, 800 SUPERIOR AVENUE, SUITE 1400, CLEVELAND, OH, 44114, US

(73) Assignee: PrintBridge Inc., Ottawa (CA)

(21) Appl. No.: 12/199,856

(22) Filed: Aug. 28, 2008

Related U.S. Application Data
(60) Provisional application No. 60/968,716, filed on Aug. 29, 2007.

(30) Foreign Application Priority Data
Dec. 21, 2007 (CA) 2616212

(51) Int. Cl. B42F 13/16

(52) U.S. Cl. 402/75

(57) ABSTRACT

A holder for loose leaf documents suitable for binding within a document is disclosed, having a pocket portion that is secured to a backer sheet along the bottom and outside edges thereof only and terminating such that the apertures provided to secure the holder to the binding mechanism appear only on a binding strip along the inside edge of the backer sheet, leaving the pocket free to flap open and shut along its inside extent for easy insertion and removal of loose leaf materials, even when the holder is bound within a document. Preferably, the holder is manufactured out of a single sheet of paper stock, suitably die cut for economic and easy manufacture, while remaining environmentally friendly.

### RELATED APPLICATION

This application claims priority to, and any other benefit of, U.S. Provisional Patent Application No. 60/968,716 filed Aug. 29, 2007 and Canadian Patent Application No. 2,616,212 filed Dec. 21, 2007, which are herein incorporated by reference.

### FIELD OF THE INVENTION

The present invention relates to office products and in particular to a novel loose leaf envelope for storing loose materials in a bound document.

### BACKGROUND OF THE INVENTION

At presentations and conferences, it is customary to provide participants with a volume of pre-printed materials for reference both during the event and subsequently.

Such materials may comprise paper copies of slides shown in the presentation and/or a supporting paper or article written for the conference or presentation.

Ideally, such volume or binder is bound by comb binding or otherwise along the (preferably, in Western society) left side, so that the materials provided will not fly out of order or be lost and pages thereof may be easily flipped through as desired. Alternatively, such materials may be hole punched along the left side and stored in a ring binder.

However, even with the advent of electronic publishing and e-mail, such materials are usually requested to be received by the presentation or conference organizer a fixed number of days in advance of the event, in order to permit their printing, collation into presentation, chronological or alphabetical order, creation of a suitable index or table of contents, binding and delivery to the event location in time for the commencement thereof.

On occasion, however, with the day-to-day hustle and bustle of modem business, the authors of some of the materials are unable to deliver their papers or presentations by the specified deadline, with the result that their papers or presentations are usually only made available in loose-leaf form and not bound within the printed materials.

Furthermore, some presentation or paper topics relate to late-breaking events, so that addenda are made available at the time of the event, again in loose leaf form, which would ideally be stored with the printed materials.

As well, some presentations are organized in a manner which requires attendees to remove handouts and/or worksheets to use during the presentation. It is preferable to replace such handouts and/or worksheets within the materials once they are no longer required.

Still further, on occasion, the materials provided to attendees may comprise physical exhibits rather than paper print-outs, which do not easily admit of binding within a comb bound document or a ring binder.

Against such eventualities, it is known to provide one or more loose leaf envelopes or holders in which late-arriving, removable and/or non-paper materials may be inserted and stored within the bound document after the document has been prepared or bound.

Such envelopes may be secured within the document and are adapted to accept such loose leaf documents and/or materials therewithin, thus providing a relatively secure holding area for such loose materials within the document itself.

For example, U.S. Pat. No. 2,091,667 and entitled “Loose Leaf Holder for Binders” and issued Aug. 31, 1937 to Barnes discloses a paper envelope to be used in combination with a binder. The envelope has a backer and pocket attached to the backer along an inside edge and the bottom of the backer. The top edge of the envelope is arcuate and descends from a point intermediate the inside edge of the backer to the bottom of the outside edge thereof. A cover portion attached to the top of the backer and a flap attached to the outside edge of the backer fold over the pocket and may be attached thereto to secure materials within the envelope. Both the backer and the pocket have a plurality of apertures therewithin along their inside edge by which the envelope may be secured within the binder.

U.S. Pat. No. 3,528,602 and entitled “Pocket Sheet for Loose-Leaf Binders” and issued Sep. 15, 1970 to Ritchie discloses a paper pocket sheet for holding papers and a method for producing the sheet. The sheet has a backer portion and a pocket attached along its bottom and inside and outside edges to the backer to secure materials within the envelope. The top edge of the pocket is arcuate and descends from the top of the outside edge of the backer to a point intermediate the inside edge of the backer. Both the backer and the pocket have a plurality of apertures therewithin along their inside edge by which the pocket sheet may be secured within the binder.

U.S. Pat. No. 4,795,287 and entitled “Loose Leaf Holder for Use with Ring Binders” and issued Jan. 3, 1989 to Friedman discloses a paper holder with a backer portion and a pocket with a horizontal top edge attached along its bottom edge thereto by a fold. The backer has a tab extending outside and attached along its outside edge that is adapted to engage a slit on the pocket to secure the outside edge of the pocket to that of the backer. Both the backer and the pocket have a plurality of apertures therewithin along their inside edge by which the holder may be secured within the binder and to secure the inside edge of the pocket to the backer. A plurality of folds along the bottom edge of the pocket and along the fold line of the tab permit the pocket to expand slightly to accommodate a greater thickness of material therewithin.

A loose leaf envelope manufactured by Esselte Ltd. under the trade-mark PENDAFLEX™ comprises a paper pocket secured to a backer portion along its inside, bottom and outside edges. The top edge of the pocket is arcuate and descends from a point intermediate the inside edge of the backer to a point intermediate the outside edge of the backer and lower than the point intermediate its inside edge. Both the backer and the pocket have a plurality of apertures therewithin along their inside edge by which the envelope may be secured within the binder. A slit along the pocket permits insertion of a business card on the front of the pocket.

A plastic loose leaf envelope manufactured by Winnable Enterprise Co., Ltd. and depicted at the URL http://www.winnable.com/binder3.htm comprises a pocket secured to a backer portion along its inside, bottom and outside edges. The top edge of the pocket is slightly arcuate and descends from substantially the top of the inside edge of the backer to a point intermediate the outside edge. Both the backer and the pocket have a plurality of apertures therewithin along their inside edge by which the envelope may be secured within the binder.

A plastic loose leaf envelope manufactured by Esselte Ltd. under the trade-mark OXFORD STASH IT™ comprises a pocket secured to a backer portion along its inside, bottom and outside edges. The top edge of the pocket is slightly arcuate and descends from substantially the top of the inside and outside edges of the pocket to a mid-point slightly lower than these points. The inside edge of the pocket is secured to the backer along a line that is inwardly offset from the inside edge of the backer, such that only the backer has a plurality of apertures therewithin along its inside edge by which the envelope may be secured within the binder. A plurality of folds along the inside, bottom and outside edges of the pocket permit the pocket to expand slightly to accommodate a greater thickness of material therewithin. The top edge of the backer sheet has a flap extending therealong by a fold that is adapted to engage the front of the pocket, such as by complementary hook and loop strips to secure the flap to the pocket.

The foregoing holders and envelopes are all characterized by a pocket that is secured to the backer portion along its bottom and inside edges when secured within the binder. In the case of Friedman, the inside edge is secured to the inside edge of the backer portion by the binding mechanism, be it a binding comb or a ring binder mechanism that extends through the corresponding apertures along the inside edges of the pocket.

Furthermore, the pocket in each of the foregoing prior art examples, is also secured along its outside edge, in the case of both Barnes and Friedman, by a flap extending along the outside edge of the backer by a flap and adapted to be secured to the pocket.

The securement of the pocket to the backer along both its inside and outside edges thereof, while preventing the materials to be stored within the holder from too easily being dislodged, also makes it difficult to insert and remove the materials to be stored therewithin. In the case of both Barnes and Friedman, a further step of engaging and/or disengaging a flap is called for.

Furthermore, none of the foregoing examples easily accommodate a thick mass of material for insertion therewithin. The Friedman and Oxford embodiments attempt to provide some such capability by the use of a plurality of folds along the edges of the pocket secured to the backer portion, but in both cases, as the pocket is secured to the backer portion along three edges thereof, and in the case of the Oxford embodiment, along substantially the entirety of each such edge of the backer portion, such expansion capability is significantly limited.

This expansion capability is still further inhibited by the fact that, with the exception of the Oxford embodiment, all of the foregoing holder and envelopes are secured to the binding mechanism through both the pocket as well as the backer portion. In so doing, the binding portion has a tendency to pinch the inside edge of the pocket, significantly limiting the extent to which the pocket may be expanded to accommodate a thickness of materials.

When the pocket and backer portion are both punched for binding and a thickness of materials are inserted into the pocket, there is resulting mechanical stress on the binding mechanism. Other documents within the binding mechanism and outside of the pocket may be damaged as a result of such stress. Finally, when the pocket and backer portion are punched and there is a large volume of documents within the pocket, there is resulting stress upon the means for adhering the pocket to the backer along or proximate to the inside edge of the backer.

Accordingly, it is desirable to provide a novel and improved holder for loose leaf materials that accommodates a wide variation in thickness of materials.

It is further desirable to provide a holder that permits the relatively easily insertion and removal of such materials.

It is still further desirable to provide a holder that nevertheless continues to securely house such loose leaf materials.

### SUMMARY OF THE INVENTION

The present invention accomplishes the foregoing by providing a holder having a pocket that is secured to a backer portion along the bottom and outside edges thereof only and terminating such that the apertures provided to secure the holder to the binding mechanism appear only on the backer portion, leaving the pocket free to flap open and shut along its inside extent for easy insertion and removal of loose leaf materials, even when the holder is bound within a document.

Preferably, the bottom and outside edges of the pocket are defined by a plurality of folds so as to accommodate a greater thickness of materials.

Preferably, the holder is manufactured out of a single sheet of paper stock, suitably die cut for economic and easy manufacture, while remaining environmentally friendly.

According to a first broad aspect of an embodiment of the present invention there is disclosed a loose leaf holder comprising:
a. a backer sheet adapted to be bound within a document along a binding strip adjacent an inside edge thereof;
b. a pocket portion adapted to be secured along a bottom and along an outside edge thereof to corresponding portions of the backer sheet and unsecured along an inside edge thereof that extends in non-overlapping fashion with the binding strip of the backer sheet;
   whereby, when the holder is bound within the document along the binding portion, loose leaf materials may be inserted into the holder along the inside edge of the pocket and restricted from falling out by the securement of the bottom and outside edges thereof to corresponding portions of the backer sheet.

According to a second broad aspect of an embodiment of the present invention there is disclosed a blank for forming a loose leaf holder comprising:
a. a backer sheet adapted to be bound within a document along a binding strip adjacent an inside edge thereof;
b. a pocket portion adapted to be secured along a bottom and along an outside edge thereof to corresponding portions of the backer sheet and unsecured along an inside edge thereof that extends in non-overlapping fashion with the binding strip of the backer sheet;
   whereby, when the holder is bound within the document along the binding portion, loose leaf materials may be inserted into the holder along the inside edge of the pocket and restricted from falling out by the securement of the bottom and outside edges thereof to corresponding portions of the backer sheet.

### BRIEF DESCRIPTION OF THE DRAWINGS

The embodiments of the present invention will now be described by reference to the following figures, in which identical reference numerals in different figures indicate identical elements and in which:

FIG. 1 shows a plan view of a holder according to an exemplary embodiment of the present invention;

FIG. 1A shows a plan view of a further embodiment of the present invention;

FIG. 2 shows a plan view of a blank from which the holder of FIG. 1 may be constructed; and

FIG. 2A shows a plan view of a further blank from which the holder of FIG. 1 may be constructed.

While the invention will be described in conjunction with the illustrated embodiment(s), it will be understood that it is not intended to limit the invention to such embodiment(s). On the contrary, it is intended to cover all alternatives, modifications and equivalents as may be included within the spirit and scope of the invention as defined by the appended claims.

### DETAILED DESCRIPTION OF THE PREFERRED EMBODIMENTS

The present invention will now be described for the purposes of illustration only in connection with certain embodiments. However, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

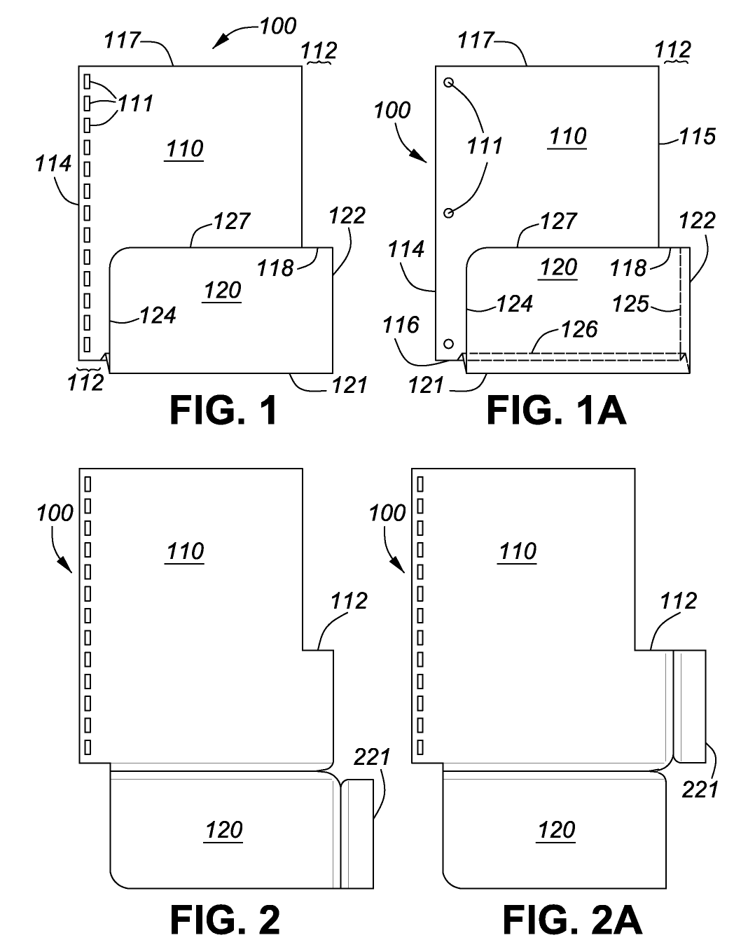

Referring first to FIG. 1, there is shown in plan view, an exemplary embodiment of a loose leaf material holder 100 according to the present invention.

The holder 100 is manufactured out of paper, which is preferably of a card stock. It comprises a backer sheet 110 and a pocket portion 120. The backer sheet 110 has the general dimensions of the printed materials with which it is to be bound, for example, as is common in North America, of substantially 8½ inches wide by 11 inches long. Indeed, the backer sheet 110 may have a slightly larger width, such as 9 inches, to accommodate a binding edge as described below.

The backer sheet 110 has a plurality of apertures 111 linearly arrayed along the extent of a binding strip 113 adjacent one edge, designated the inside edge 114. In most Western cultures, where reading is from left to right along a page and binding is along the left edge, the inside edge 114 corresponds to the left side of the backer sheet 110.

FIG. 1 shows the pocket portion 120 on the front of the backer sheet 110. Those having ordinary skill in this art will appreciate that FIG. 1 could be reversed right to left, resulting in a front-facing pocket for use in those cultures where texts are read from the right to the left, or in a rear-facing pocket for use in Western left to right reading cultures.

The apertures 111 may be rectangular to correspond with comb binding as shown in FIG. 1 or circular and spaced apart along the extent of the binding strip 113 as shown in FIG. 1a, corresponding to hole punching for insertion into a ring binder. Indeed, those having ordinary skill in this art will appreciate that any suitable document binding mechanism, including spiral binding, WIRE-O™ binding, taping, gluing or sewing of the inside edges, with or without apertures may be used as well without departing from the spirit and scope of the present invention.

In the embodiment shown in FIG. 1, and as may be better appreciated from consideration of FIG. 2, a notch 112 may be created in the backer sheet 110 along the outside edge 115 thereof from the top edge of the backer sheet 110 until substantially the point 118 at which the pocket portion 120 terminates, as discussed below, in order to permit materials inserted into the holder 100, to be grasped along their outside edge while minimising the likelihood of grasping the outside edge 115 of the backer sheet 110 as well. The width of the notch 112 may be of such dimension as is appropriate to permit differentiation between the bundle of materials and the backer sheet 110. In the exemplary embodiment shown, a notch 112 of approximately ½ inch wide may be appropriate for this purpose.

The pocket portion 120 is similarly manufactured out of paper, preferably card stock, and may be, as shown in FIG. 2, integral with the backer sheet 110. The pocket portion 120 is smaller than the backer sheet 110, extending only a portion of the height of the backer sheet 120, and corresponding generally to the width of the backer sheet 110 and being narrower than it by a small offset, which may be 1 inch, as shown in the exemplary embodiment of FIG. 1, so that when the respective outside 115, 125 and bottom 116, 126 edges of the backer sheet 110 and the pocket portion 120 are lined up, the top edge 127 of the pocket portion 120 corresponds with a shoulder portion of the notch 112 and the inside edge 124 of the pocket portion 120 does not obscure the apertures 111 on the binding strip 113 of the backer sheet 110.

Thus, the holder 100 may be secured by the chosen binding mechanism within a document (not shown) along the binding edge of the backer sheet 110, without interference from the pocket portion 120.

Preferably, the inside 124 and top 127 edges of the pocket portion 120 terminate in a curved section, which is primarily for aesthetic purposes, but may reduce the likelihood of the intersection of these edges becoming caught or folded over.

While the pocket portion 120 is shown in FIG. 1 with its top edge 127 extending horizontally at a point intermediate the outside edge 115 of the backer sheet 110, those having ordinary skill in this art will appreciate that the configuration of the inside 124 and top 127 edges of the pocket portion 120 may be varied in curvature, height and width, without departing from the spirit and scope of the present invention.

The pocket portion 120 is secured to the backer sheet 110 along the extent of their respective bottom edges 116, 126 by a plurality of folded segments 121 and along their respective outside edges 115, 125 by a corresponding plurality of folded segments 122, that cooperate to form a pleated or accordion-like expansion section to accommodate a greater thickness of loose leaf materials.

As may be seen in FIG. 2, each plurality of folded segments 121, 122 terminate in a tapered profile to inhibit interference between the resulting set of intersecting pleats.

Thus, the holder 100 may sit within the document (not shown) in compressed or folded fashion awaiting the insertion of materials, without significantly adding to the bulk or thickness of the document itself. Depending upon the dimensions chosen, the holder 100 will not protrude at all or significantly beyond the upper or outside edges of the document so as to remain relatively unobtrusive.

The position within the document at which the holder may be positioned is at the choice of the compiler of the document. For example, a single holder 100 may be introduced at a given spot within the document, for example, at (thus comprising one of the covers thereof) or near the front or back of the document, or a plurality of documents may be introduced, for example, as constituting each of the section dividers within the document. In one particularly preferred orientation, the pocket 120 may in fact be rear-facing, so that the backer sheet 110 may be printed on an/or tabbed and act as a section divider and the pocket portion 120 may lie behind it to accept any loose leaf materials intended for the section demarcated by the divider. In such an orientation, as discussed above, the orientation of the apertures 111 and of the inside and outside edges shown in the figures may be reversed.

Wherever the holder 100 is located and however oriented, when loose leaf materials are to be inserted therein, it is a simple matter of flipping the pocket portion 120, at the top inside edge thereof, slightly away from of the backer sheet 110 to create a space into which the materials may be inserted. Because the inside edge 124 of the pocket portion 120 is not secured in any fashion to the backer sheet 110 and no securement device, such as a ring binder mechanism or a binding comb engages it even when bound, the pocket portion 120 may be flipped considerably away from the backer sheet 110, permitting both easy access when inserting and/or removing the materials and permitting the insertion of a considerable thickness of material without significant constraint.

Further, because the outside 125 and bottom 126 edges of the pocket portion 120 are completely secured to the outside 115 and bottom 116 edges of the backer sheet 110, once materials have been so inserted into the holder 100 and the document has been closed, the inside edge 124 of the pocket portion 120 is tucked back against the loose leaf materials and the rest of the document so that there is little likelihood of the materials becoming dislodged or falling out of the document.

Moreover, because the inside edge 124 of the pocket portion 120 is not bound, a thickness of loose leaf materials within the pocket portion 120 will not put stress upon the binding mechanism or materials from the document (not shown) that are bound. Also, there will be no stress upon the means for adhering the pocket portion 120 to the backer sheet 110 along or proximate to the inside edge 114 of the backer sheet 110. These results are achieved while limiting the width of the holder 110 to 9 inches or less. Though all widths are contemplated, a width of 9 inches or less will permit the insertion of the holder 110 within the document (not shown) such that a portion of the holder 110 does not protrude from the document.

As well, securing the bottom 126 and outside 125 edges of the pocket portion 120 to corresponding edges 116, 115 respectively of the backer sheet 110, ensures that the document remains relatively presentable, despite containing therewithin a number of loose leaf enclosures.

Referring now to FIG. 2 and FIG. 2A, it may be seen that the inventive holder 100 may be composed of a single sheet of card stock, which can be die cut to suitable dimensions in a single stamping operation.

Furthermore, the construction of the inventive holders 100 shown in FIG. 2 and FIG. 2A is also simple. The holder 100 seen in FIG. 2 consists of a number of folds (which may be facilitated by folds created during the stamping operation) and a single edge, namely a tab 221 extending from the outside edge of the pocket 120, being glued to a corresponding surface of the backer sheet 110. Alternatively, as seen in FIG. 2A, the tab 221 may extend from the outside edge of the notch 112.

Of course, those having ordinary skill in this art will appreciate that the pocket 120 of the inventive holder 100 may comprise a separate sheet, glued or otherwise secured to the backer sheet 110.

It will be apparent to those having ordinary skill in this art that various modifications and variations may be made to the embodiments disclosed herein, consistent with the present invention, without departing from the spirit and scope of the present invention. Other embodiments consistent with the present invention will become apparent from consideration of the specification and the practice of the invention disclosed therein. Accordingly, the specification and the embodiment are to be considered exemplary only, with a true scope and spirit of the invention being disclosed by the following claims.

What we claim as our invention:

1. A loose leaf holder comprising:
a. a backer sheet adapted to be bound within a document along a binding strip adjacent an inside edge thereof;
b. a pocket portion adapted to be secured along a bottom and along an outside edge thereof to corresponding portions of the backer sheet and unsecured along an inside edge thereof that extends in non-overlapping fashion with the binding strip of the backer sheet;
whereby, when the holder is bound within the document along the binding portion, loose leaf materials may be inserted into the holder along the inside edge of the pocket and restricted from falling out by the securement of the bottom and outside edges thereof to corresponding portions of the backer sheet.

2. A loose leaf holder according to claim 1, comprising a plurality of folds along each of the bottom and outside edges of the pocket to provide an expandable portion adapted to accept a thickness of loose leaf materials within the pocket.

3. A loose leaf holder according to claim 1, comprising a plurality of folds along the bottom edge of the pocket and an outside edge of a notch on the backer sheet to provide an expandable portion adapted to accept a thickness of loose leaf materials within the pocket.

4. A loose leaf holder according to claim 1, wherein the backer sheet comprises a notch along its outside edge thereof beyond the portion secured to the outside edge of the pocket, whereby loose leaf materials stored within the pocket may be grasped along the outside edge of the holder without grasping the backer sheet.

5. A loose leaf holder according to claim 1, wherein the binding portion of the backer sheet comprises a plurality of apertures adapted to matingly engage with a binding fastener of the document.

6. A loose leaf holder according to claim 5, wherein the binding fastener is a ring binder.

7. A loose leaf holder according to claim 5, wherein the binding fastener is a binding comb.

8. A loose leaf holder according to claim 1, wherein the pocket portion and the backer sheet are integral and adjacent at an edge selected from the group consisting of the bottom edge and the outside edge of the pocket, the holder further comprising means for securing a remaining edge selected from the group to a corresponding portion of the backer sheet.

9. A loose leaf holder according to claim 8, wherein the means for securing is a flap extending from the remaining edge.

10. A loose leaf holder according to claim 1, wherein the pocket and the backer sheet are composed of card stock.

11. A blank for forming a loose leaf holder comprising:
a. a backer sheet adapted to be bound within a document along a binding strip adjacent an inside edge thereof;
b. a pocket portion adapted to be secured along a bottom and along an outside edge thereof to corresponding portions of the backer sheet and unsecured along an inside edge thereof that extends in non-overlapping fashion with the binding strip of the backer sheet;
whereby, when the holder is bound within the document along the binding portion, loose leaf materials may be inserted into the holder along the inside edge of the pocket and restricted from falling out by the securement of the bottom and outside edges thereof to corresponding portions of the backer sheet.
